(19) United States
(12) Patent Application Publication
(10) Pub. No.: US 2024/0168291 A1
(43) Pub. Date: May 23, 2024

(54) HIGH-CONTRAST LIQUID CRYSTAL PANEL

(71) Applicant: Meta Platforms Technologies, LLC, Menlo Park, CA (US)

(72) Inventors: Xinyu Zhu, San Jose, CA (US); Rungrot Kitsomboonloha, Los Gatos, CA (US); Hsin-Ying Chiu, San Jose, CA (US); Cheonhong Kim, Mountain View, CA (US)

(21) Appl. No.: 18/106,165

(22) Filed: Feb. 6, 2023

Related U.S. Application Data
(60) Provisional application No. 63/426,580, filed on Nov. 18, 2022.

(51) Int. Cl. G02B 27/01; G02F 1/1335

(52) U.S. Cl. CPC G02B 27/0172; G02F 1/133531

(57) ABSTRACT

A liquid crystal panel may include a layer with a plurality of rounded rectangular structures such as through vias of an active matrix layer. A loss of contrast may result from the illuminating light undergoing a Fresnel refraction by the rounded rectangular structures. In particular, rounded walls of the structures may rotate a direction of polarization of a linearly polarized illuminating light, causing light leakage in the black state of the panel. Reduction of the rounded portions of the vias may improve the overall contrast of the LC panel, as well as orienting the polarization of the impinging illuminating light to be parallel or perpendicular to the structures.

### REFERENCE TO RELATED APPLICATION

This application claims priority from U.S. Provisional Patent Application No. 63/426,580 entitled “HIGH-CONTRAST LIQUID CRYSTAL PANEL”, filed on Nov. 18, 2022 and incorporated herein by reference in their entirety.

### TECHNICAL FIELD

The present disclosure relates to liquid crystal displays and related components, modules, systems, and methods.

### BACKGROUND

Visual displays provide information to viewer(s) including still images, video, data, etc. Visual displays have applications in diverse fields including entertainment, education, engineering, science, professional training, advertising, to name just a few examples. Some visual displays such as TV sets display images to several users, and some visual display systems such s near-eye displays (NEDs) are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in a VR system, a liquid crystal display may be used to provide images of virtual objects.

Because a display of HMD or NED is usually worn on the head of a user, a large, bulky, unbalanced, and/or heavy display device with a heavy battery would be cumbersome and uncomfortable for the user to wear. Consequently, the liquid crystal display panels used in NED systems tend to be small and have a tight pixel pitch. To provide rich, dynamic VR imagery, the liquid crystal displays also need to have a fast frame rate, low latency, high resolution, and a high contrast ratio, while remaining small.

### BRIEF DESCRIPTION OF THE DRAWINGS

Exemplary embodiments will now be described in conjunction with the drawings, in which:

FIG. 1 is a schematic side cross-sectional view of a liquid crystal (LC) panel of this disclosure;

FIG. 2A is a frontal view of the LC panel of FIG. 1 in a bright state;

FIG. 2B is a frontal view of the LC panel of FIG. 2A in a dark state, showing light leakage from through via regions of the LC panel;

FIG. 2C is a side cross-sectional view of an active matrix layer of the LC panel of FIG. 2A, the active matrix layer having through vias causing the light leakage illustrated in FIG. 2B;

FIG. 3 is an illustration of refraction of a light beam;

FIG. 4A is an angular plot of transmission coefficients for an interface with 1.5/1.6 refractive indices;

FIG. 4B is an angular plot of transmission coefficients for an interface with 1.5/1.8 refractive indices;

FIGS. 5A, 5B, and 5C are schematic polarization diagrams illustrating a polarization rotation by a skewed refractive interface die to the transmission coefficients difference illustrated in FIGS. 4A and 4B;

FIGS. 6A, 6B, and 6C are plan views of via shapes with progressively improving polarization maintaining performance in going from FIG. 6A to FIG. 6B to FIG. 6C;

FIG. 6D is a plan view of a rounded rectangular shape illustrating the definition of an acceptable ratio of the rounded perimeter portion to the total perimeter of the shape;

FIG. 7A is a side cross-sectional view of the LC panel of FIGS. 2A and 2B illustrating evolution of polarization of a light beam propagating through the liquid crystal panel with transparent unshielded vias;

FIG. 7B is a schematic view of a near-eye display using the LC panel of FIG. 7A;

FIG. 8 is a flow chart of a method for increasing a contrast ratio of an LC panel;

FIG. 9 is a top view of wearable display of this disclosure having a form factor of a pair of eyeglasses; and

FIG. 10 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated.

Fast liquid crystal (LC) panels with tight pixel pitch required for compact VR displays suffer from a contrast loss due to several reasons. Firstly, using fast positive LC fluid in a fringe field switched (FFS) configuration may cause optical transmission loss at a comparable light leakage in the dark state, which reduces the contrast ratio. Secondly, smaller pixels of smaller display panels have larger edge or fringe effects in proportion to the overall pixel area, contributing to the light leakage. Thirdly, small structures of miniature, high-pixel-count display panels may be prone to light leakage through the small structures. The light leakage may be caused by diffraction effects, polarization effects, electrical field fringe effects, etc.

In the present disclosure, a light leakage caused by polarization effects is considered and addressed. Polarization effects may occur on rounded walls of small structures such as through vias in an active matrix layer of an LC panel. The through vias are used to electrically couple different sub-layers in a structured layer of the LC panel, for example an active matrix layer. The rounded walls of the through vias, or any other skewed refractive interfaces for that matter, rotate a plane of polarization of impinging light due to Fresnel transmission effects. To reduce the light leakage caused by Fresnel effects on skewed refractive interfaces, at least one of the following can be done: reducing a radius of curvature of a rounded area of the rectangular structures; orienting a linear polarization of impinging light to be parallel or perpendicular to the refractive walls; shielding the rounded areas from light; and/or index matching the rectangular structures to their immediate environment.

In accordance with the present disclosure, there is provided a liquid crystal (LC) panel comprising opposed first and second substrates separated by a gap between the first and second substrates. An LC layer comprising LC molecules is disposed in the gap. The LC panel further includes a structured layer parallel to the LC layer. The structured layer comprises a plurality of rounded rectangular structures having a perimeter in a plane of the structured layer and refractive walls extending from the perimeter towards the first or the second substrate. A sum length of rounded portions of the perimeter is no greater than 50%, 30%, or 10% of a total length of the perimeter. In some embodiments, the perimeter is no longer than 40, 24, or 8 micrometers.

In some embodiments, the LC panel comprises a linear polarizer supported by the first substrate or the second substrate. A transmission axis of the linear polarizer may be perpendicular or parallel to straight portions of the perimeter of the rounded rectangular structures. The structured layer may include an active matrix layer disposed on the second substrate and facing the LC layer, for providing a spatially variant electric field distribution to the LC layer for spatially variant reorientation of the LC molecules in a plane of the LC layer. The active matrix layer may include the rounded rectangular structures, and the rounded rectangular structures may include vias for electrical coupling of different sub-layers of the active matrix layer. The vias may include a transparent oxide. The active matrix layer may further comprise a material surrounding the rounded rectangular structures, and the rounded rectangular structures may be index matched to the surrounding material to within 0.1.

In accordance with the present disclosure, there is provided a method for increasing a contrast ratio of an LC panel comprising a substrate, a layer comprising a plurality of rounded rectangular structures having a perimeter in a plane of the layer, and refractive walls extending from the perimeter towards the substrate. The method comprises selecting a sum length of rounded portions of the perimeter to be no greater than 50% of a total length of the perimeter of the rounded rectangular structures, for lessening a contribution of rounded portions of the refractive walls to perturbation of a linear polarization of impinging light due to refraction of impinging light on the rounded portions of the refractive walls. The sum length of rounded portions of the perimeter may be e.g. no greater than 50%, 30%, or 10% of a total length of the perimeter. In some embodiments, the perimeter is no longer than 40, 24, or 8 micrometers.

The method may further include orienting a linear polarizer supported by the substrate to have a transmission axis of the linear polarizer perpendicular or parallel to straight portions of the perimeter of the rounded rectangular structures, and/or index matching the rounded rectangular structures to their surroundings to reduce the refraction of the impinging light by the rounded rectangular structures.

In accordance with the present disclosure, there is further provided a near-eye display comprising an LC panel of this disclosure, an illuminator for illuminating the LC panel, and an ocular lens for viewing the LC panel. In some embodiments, the structured layer of the LC panel comprises an active matrix layer disposed on the second substrate and facing the LC layer, for providing a spatially variant electric field distribution to the LC layer for spatially variant reorientation of the LC molecules in a plane of the LC layer. The active matrix layer may include the rounded rectangular structures, and the latter may include vias for electrical coupling of different sub-layers of the active matrix layer.

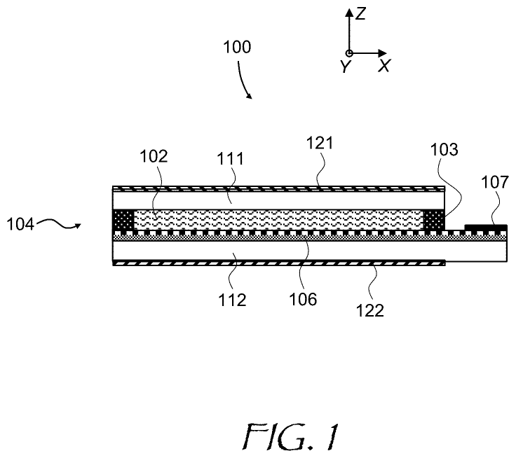

Referring to FIG. 1, a liquid crystal (LC) panel 100 includes an LC layer 102, such as e.g. an LC fluid with or without a stabilizing polymer network, in an LC cell 104. The LC cell 104 is formed by top 111 and bottom 112 substrates and sealed by an edge seal 103. At least one of the top 111 or bottom 112 substrates may be transparent. In some embodiments, the top substrate 111 is transparent and the bottom substrate 112 is reflective, i.e. the LC panel 100 may have a reflective configuration. In some embodiments, both the top 111 and bottom 112 substrates are transparent, i.e. the LC panel 100 may have a transmissive configuration.

The bottom substrate 112 may support a structured layer facing the LC layer 102, such as e.g. an active matrix layer 106 including an array of electrodes, e.g. a two-dimensional array of electrodes to define a spatially variant lateral (i.e. XY-plane) electric field distribution, which determines a LC layer 102 birefringence distribution caused by local, spatially variant reorientation of LC molecules in the applied electric field. The lateral birefringence distribution may be converted into a transmission, or a grayscale level distribution corresponding to an image to be displayed by the LC panel 100, by using a pair of polarizers 121, 122. For reflective configurations of the LC panel 100, the lateral birefringence distribution may be converted into a reflectivity, without the need of the bottom polarizer 122. Herein, the term “grayscale” is applied to both black and white (b/w) and color pixels, meaning a brightness level of the pixel, being b/w or color pixel, as the case may be. The active matrix layer is accessed by means a plurality of electrical contacts 107.

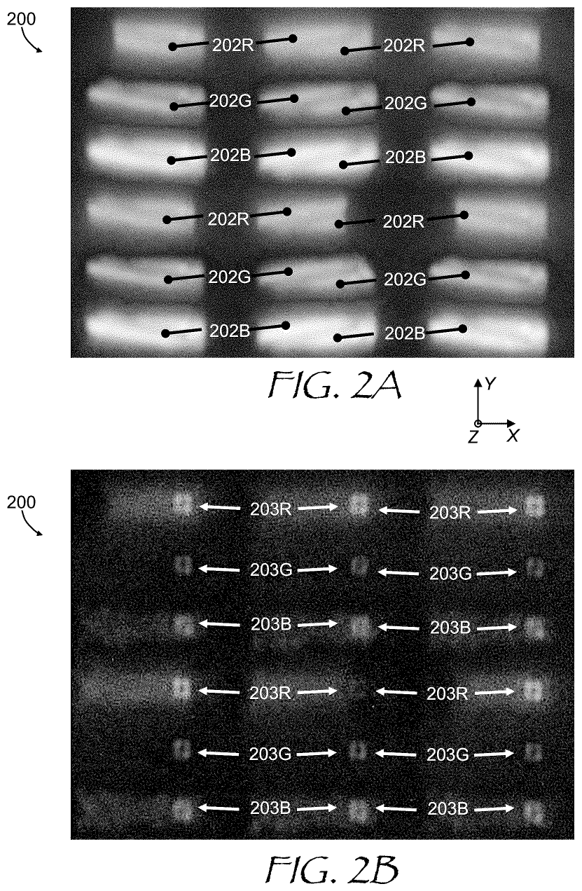

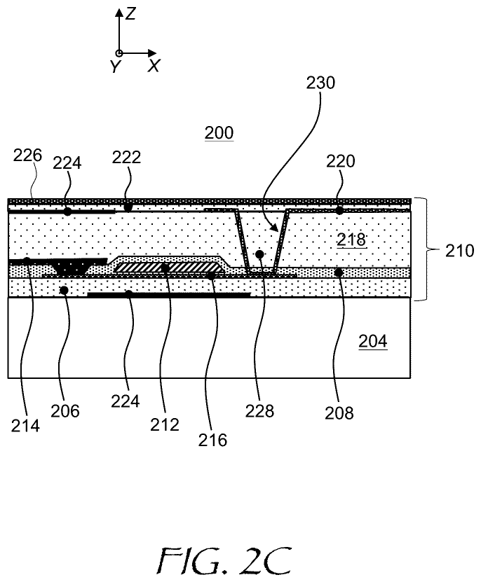

FIG. 2A is a photograph of a top surface of a high-pitch miniature LC color display panel 200 in a bright state when red 202R, green 202G, and blue 202B color sub-pixels are tuned to a maximum brightness level (i.e. all pixels ON). FIG. 2B is a photograph of a dark state of the same red 202R, green 202G, and blue 202B color sub-pixels of the LC display panel when the color sub-pixels are turned to minimum brightness level (all pixels OFF), revealing light leakage from areas 203R, 203G, and 203B of the sub-pixels of the LC panel 200. It is seen that the leaking light in the leakage areas 203R, 203G, and 203B is composed of small quadrants. It has been determined that the location of these quadrants correlates with locations of through vias in an active matrix layer of the display panel 200.

FIG. 2C illustrates a cross-section of the active matrix layer of the LC panel 200. The LC panel 200 includes a substrate 204, e.g. a glass substrate, which corresponds to the bottom substrate 112 of the LC panel 100 of FIG. 1. The substrate 204 of FIG. 2C supports an active matrix (AM) layer 210 including a buffer layer 206, an insulating layer 208, a gate electrode 212 and a source electrode 214 contacting a semiconductor thin film transistor (TFT) layer 216 such as e.g. Indium gallium zinc oxide (IGZO), a planarization layer 218, a pixel electrode layer 220, an insulating layer 222, and light shield layers 224. A common electrode layer 226 is disposed on the insulating layer 222. A through via 228 electrically couples the pixel electrode layer 220 to the TFT layer 216. The through via 228, the pixel electrode 220, and the common electrode 226 layers may include a conductive transparent oxide such as indium tin oxide (ITO), for example. The leakage areas (quadrants) of FIG. 2B correspond to the corners of the vias 228 of FIG. 2C.

The origins of the leaking light of FIG. 2B will now be explained.

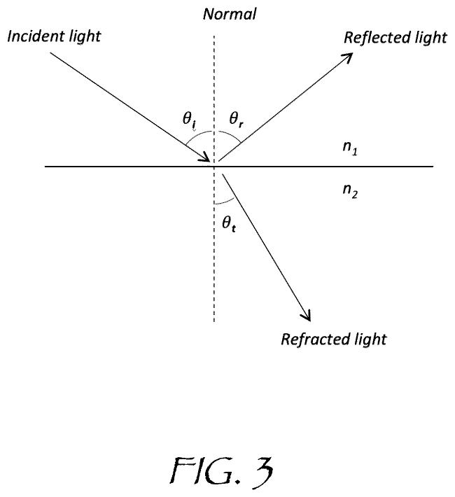

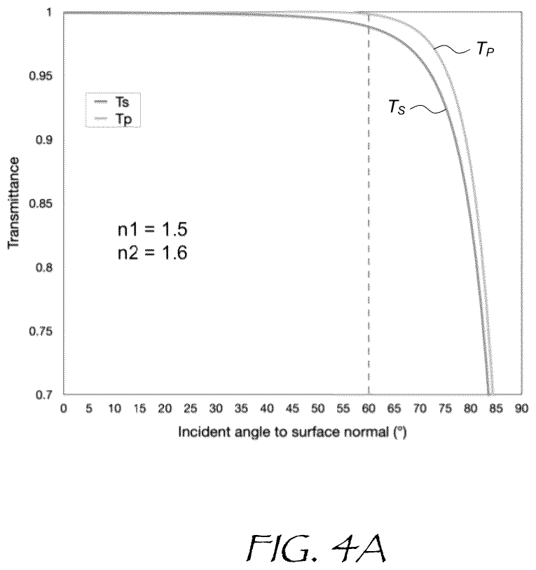

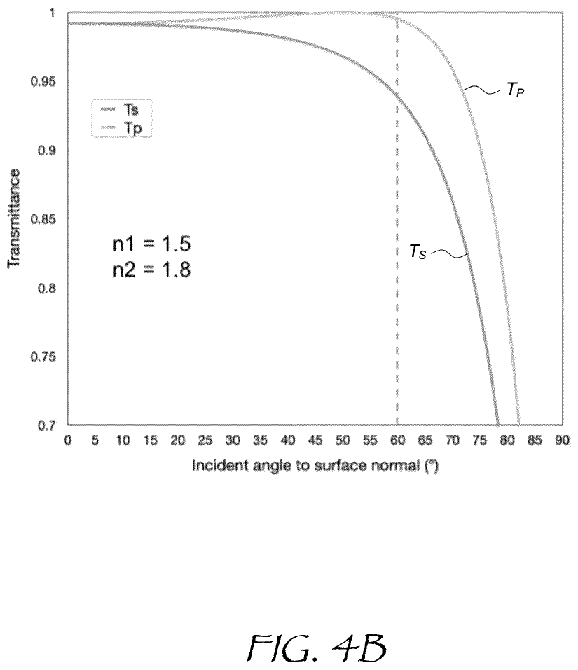

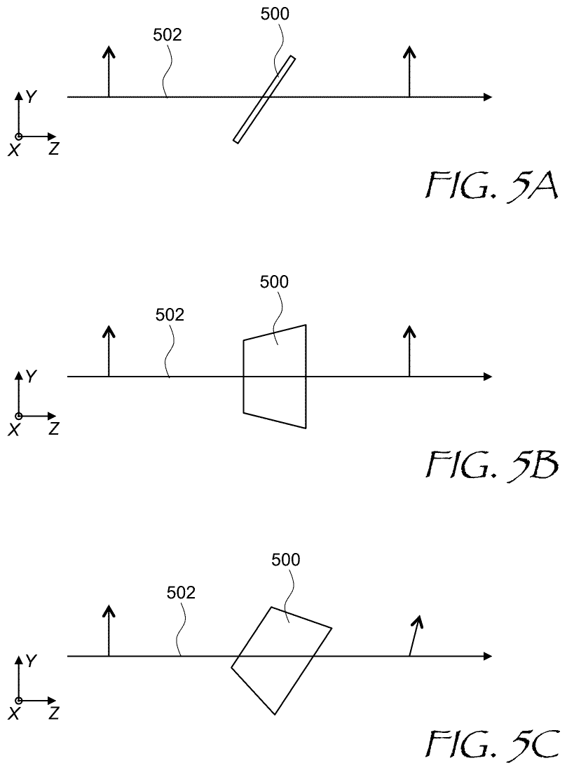

FIG. 3 illustrates a Fresnel refraction of light at an interface between two transparent media with different refractive indices. The reflection and transmission coefficients depend on the polarization state, the angle of incidence θᵢ, and the ratio of refractive indices n₁ and n₂ of the two transparent media. If the second refractive index n₂ is higher than the first refractive index n₁, the angle of refraction θₜ will be smaller than the angle of incidence θᵢ, with the angle of reflection θᵣ being always equal to the angle of incidence θᵢ. The reflection R_{S}, R_{P} and transmission T_{S}, T_{P} coefficients for s and p polarizations can be determined from the following Fresnel equations (1) and (2):

$$\begin{matrix}R \text{?} = {\vert \frac{{n}_{1} cos θ \text{?} - {n}_{2} cos θ \text{?}}{{n}_{1} cos θ \text{?} + {n}_{2} cos θ \text{?}} \vert}^{2} = {\vert \frac{{n}_{1} cos θ \text{?} - {n}_{2} \sqrt{1 - {( \frac{{n}_{1}}{{n}_{2}} sin θ \text{?} )}^{2}}}{{n}_{1} cos θ \text{?} + {n}_{2} \sqrt{1 - {( \frac{{n}_{1}}{{n}_{2}} sin θ \text{?} )}^{2}}} \vert}^{2} \\ {R}_{p} = {\vert \frac{{n}_{1} cos θ \text{?} - {n}_{2} cos θ \text{?}}{{n}_{1} cos θ \text{?} + {n}_{2} cos θ \text{?}} \vert}^{2} = {\vert \frac{{n}_{1} \sqrt{1 - {( \frac{{n}_{1}}{{n}_{2}} sin θ \text{?} )}^{2}} - {n}_{2} cos θ \text{?}}{{n}_{1} \sqrt{1 - {( \frac{{n}_{1}}{{n}_{2}} sin θ \text{?} )}^{2}} + {n}_{2} cos θ \text{?}} \vert}^{2}\end{matrix} \qquad ( 1 )$$

$$\begin{matrix}{T}_{P} = 1 - {R}_{P} \\ {T}_{S} = 1 - {R}_{S}\end{matrix} \qquad ( 2 )$$

$$\text{?} \text{indicates text missing or illegible when filed}$$

Referring to FIG. 4A, Eqs. (1) and (2) are illustrated for a case where the first refractive index n₁=1.5 and the second refractive index n₂=1.6, corresponding to the refractive index step of 0.1. It is seen that a transmittance curve T_{P} for p-polarized light runs very closely to a transmittance curve T_{S} for s-polarized light up to angles of incidence of about 45 degrees, the difference quickly growing at angles of incidence of over 60 degrees. Referring to FIG. 4B, Eqs. (1) and (2) are illustrated for a case where the first refractive index n₁=1.5 and the second refractive index n₂=1.8, corresponding to the refractive index step of 0.3. It is seen that the difference between s- and p-transmittances grows much quicker with a larger refractive index mismatch at the interface between the two transparent media. Especially at oblique angles of incidence θᵢ, the difference between transmittance of the s- and p-polarized light can be quite high. One can see by comparing FIG. 4B to FIG. 4A that the difference transmittance of the s- and p-polarized light increases with the ratio of n₂/n₁.

FIGS. 5A to 5C illustrate how a refractive interface may rotate the polarization angle of impinging linearly polarized light. FIG. 5A illustrates a case when a refractive interface 500, shown as a tilted rectangle, is tilted about x-axis, which is perpendicular to a plane of FIG. 5A. An impinging light beam 502 is p-polarized w.r.t. the interface 500, i.e. polarized along y-axis. The output polarization direction does not change, because there is no s-component in the impinging light and, accordingly, the ratio of s- to p-polarized light does not change.

FIG. 5B illustrates a similar configuration, where the refractive interface 500 is tilted about y-axis, which is parallel to the plane of FIG. 5B. The impinging light beam 502 is s-polarized w.r.t. the interface 500. The output polarization direction does not change because there is no p-component in the impinging light and, accordingly, the ratio of p- to s-polarized light does not change.

FIG. 5C illustrates a case where the refractive interface 500 is tilted about both x- and y-axes. For such skewed angle of incidence, the impinging light beam 502 includes both p- and s-polarized components w.r.t. the interface 500. The s- and p-polarized components add as vectors to the initial polarization. Since the transmission coefficients for the p- and s-polarized light are different from one another (see e.g. FIGS. 4A, 4B), upon refraction the s- and p-polarized vector components will add as vectors to a differently directed polarization state vector. The direction change of the linear polarization of the impinging light causes the light leakage seen in FIG. 2B.

In accordance with the findings disclosed herein, the slanted or tilted refractive interface may appear e.g. due to sidewalls 230 of through vias, such as the via 228 of the active matrix layer 210 shown in FIG. 2C. The via 228 of FIG. 2C has a certain radius of curvature. The curved rounded areas of the through vias 228 may be represented as a plurality of the slanted flat interface segments of FIG. 5C. Accordingly, the rounded sidewalls of the through vias 228 causes the light leakage due to the Fresnel polarization rotation described above with reference to FIG. 5C.

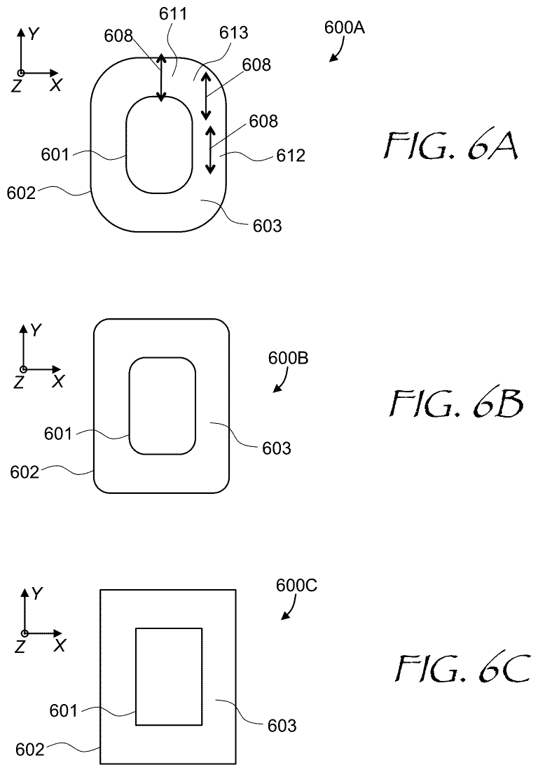

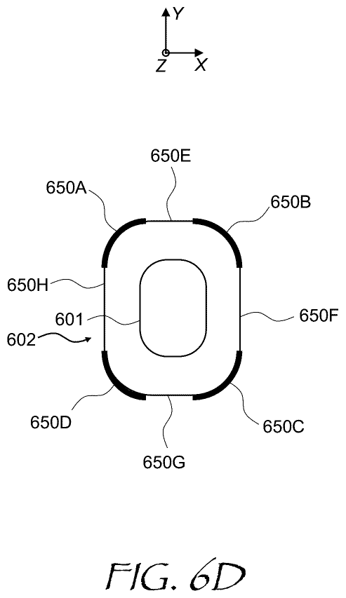

Any rounded rectangular structures having a perimeter in a plane of a structured layer, such as the active matrix layer 210 for example, with refractive walls extending from the perimeter towards one of the substrates of the LC panel, may cause polarization rotation, light leakage in the dark state and associate image contrast loss. Such contrast loss will be especially noticeable for panels with small pixel size, since the vias will occupy a larger percentage of the smaller pixel. The rounded rectangular structures are illustrated in top (plan) view in FIGS. 6A through 6C, with the FIG. 6A showing the most rounded structures, FIG. 6B showing less rounded structures, and FIG. 6C showing an “ideal” case with a negligible roundness of the structures.

Referring first to FIG. 6A, a rounded rectangular structure 600A includes a bottom perimeter 601, a top perimeter 602, and slanted refractive walls 603 extending between the bottom 601 and top 602 perimeters, i.e. extending towards one of the substrates extending parallel to the XY plane, i.e. to the plane of FIG. 6A. A light beam linearly polarized along Y-axis as indicated with arrows 608 will be p-polarized relative to a top side refractive sidewall 611, which corresponds to the geometry illustrated in FIG. 5A. The light beam polarized at 608 will be s-polarized relative to a right hand side refractive sidewall 612, which corresponds to the geometry illustrated in FIG. 5B. The light beam polarized at 608 will have a skewed polarization relative to a top right corner rounded refractive sidewall 613, which corresponds to the geometry illustrated in FIG. 5C, and so it will be for the remaining three rounded corners of the rounded rectangular structure 600A. It is the rounded corners of the rounded rectangular structure 600A that cause the polarization rotation and an associated dark-state light leakage, as shown in the photo of FIG. 2B at the areas of quadrants or leakage areas 203R, G, B.

FIG. 6B illustrates a shape 600B that has less Fresnel light leakage than the shape of FIG. 6A, due to tighter corner radius than in FIG. 6A; and FIG. 6C illustrates an ideal case shape 600C where the corner radius is substantially zero, resulting in a zero light leakage. An acceptable roundness of corners from the viewpoint of its impact on the contrast ratio of an LC panel may be defined in the following manner.

Referring to FIG. 6D, the roundness may be defined as a ratio of a length of rounded portions of a shape's perimeter to its overall perimeter length. A definition of the ratio of the rounded areas to the rectangular areas may be introduced as follows. In accordance with this disclosure, to reduce the polarization leakage, the radius of curvature of the rounded areas needs to be reduced to lessen a length of rounded areas of the rectangular structures. In FIG. 6D, the length of the rounded perimeter portions may be found as the sum length R of all round corner edges shown with thick solid lines, specifically 650A (length A), 650B (length B), 650C (length C), and 650D (length D). The total perimeter length P is the length of the round corner edges R=A+B+C+D plus the length S=E+F+G+H of the straight edges 650E, 650F, 650G, and 650H. In accordance with this disclosure, the ratio R/P=R/(R+S) may be no greater than e.g. 50%, preferably 30%, and more preferably 10% of the total perimeter length P of the rounded rectangular structures. The perimeter may be no longer than 40 micrometers, preferably no longer than 24 micrometers, and more preferably no longer than 8 micrometers. The rounded rectangular structures may include rounded square structures.

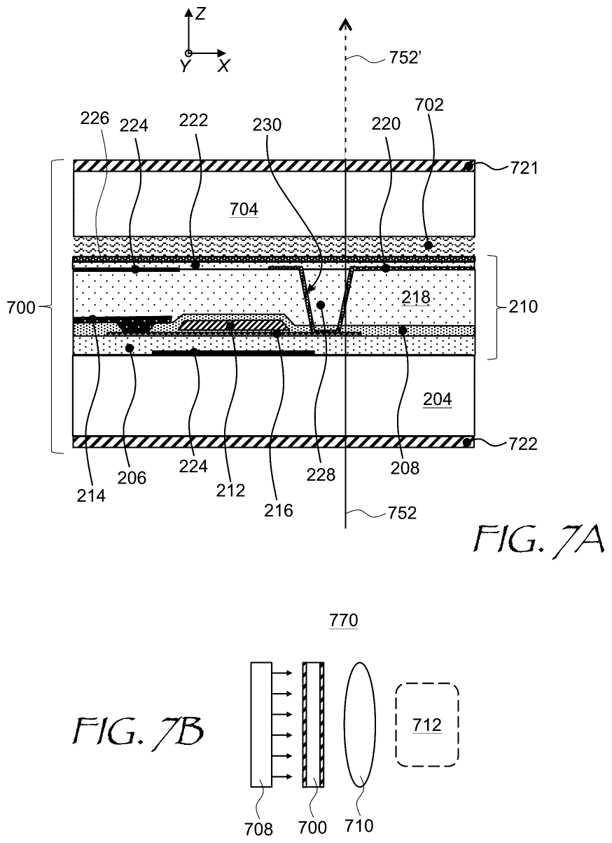

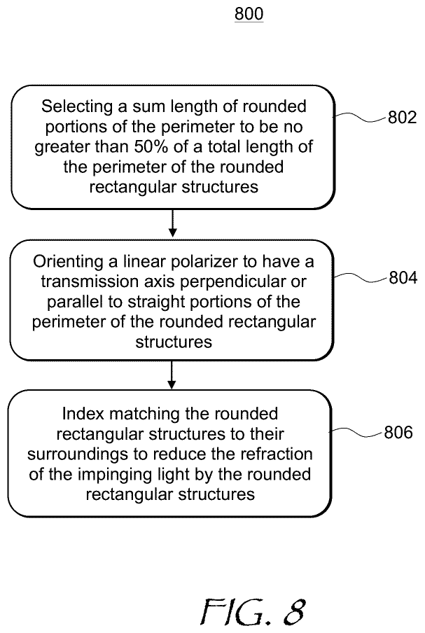

Referring to FIG. 7A, the LC panel 200 of FIGS. 2A and 2B with the active matrix layer 210 of FIG. 2C is shown in a side cross-sectional view. Relative thicknesses of various layers are not representative of actual thicknesses ratios in FIG. 7A. The LC panel 200 includes an LC layer 702 in a gap formed by opposed bottom 204 and top 704 substrates, e.g. glass or plastic substrates. The substrate 204 supports the buffer layer 206, the insulating layer 208, the TFT layer 210 including the gate electrode 212 and the source electrode 214 contacting a semiconductor thin film transistor (TFT) layer 216, the planarization layer 218, the pixel electrode layer 220, the insulating layer 222, and the light shield layers 224. The common electrode layer 226 is disposed on the insulating layer 222. The via 228 electrically connects the pixel electrode layer 220 to the TFT layer 216. A top polarizer 721 is laminated onto the top substrate 704, and a bottom polarizer 722 is laminated onto the bottom substrate 204.

The polarization evolution of an unpolarized illuminating light beam 752 will now be described. The light beam 752 gets linearly polarized by the bottom polarizer 722. Upon propagation through a rounded portion of the sidewall 230 of the via 228, the polarization direction of the light beam 752 is rotated due to the difference in Fresnel transmission coefficients as explained above with reference to FIGS. 5A to 5C and Eqs. (1) and (2) above. After propagation through the LC layer 702 driven to the dark state, the polarization of the light beam 752 becomes elliptical, which would not happen if the polarization of the light beam 752 were not rotated by propagation through the sidewall 230 of the via 228. The elliptical polarization causes light leakage 752′ through the top polarizer 721.

To reduce the light leakage, the rounded portions of the sidewalls 230 may be reduced as explained above with reference to FIGS. 6A to 6D. The ratio R/P=R/(R+S) of the rounded rectangular structures may be selected to be no greater than e.g. 50%, preferably 30%, and more preferably 10% of the total perimeter length P of the rounded rectangular structures. The perimeter may be no longer than 40 micrometers, preferably no longer than 24 micrometers, and more preferably no longer than 8 micrometers. Herein and throughout the specification, the term “rounded rectangular” as opposed to simply “rectangular” refers to structures having over 0.1% of the rounded portion of the perimeter.

In addition to/instead of reducing the rounded areas of vias, the vias areas may be index matched to the surrounding material to e.g. within 0.1, and more preferably to within 0.05. Furthermore, a transmission axis of the bottom linear polarizer 722 may be selected to be perpendicular or parallel to straight portions of the perimeter of the rounded rectangular structures. Any combination of the above measures may be used to reduce the light leakage and improve the overall contrast ratio. The rounded areas may also be completely shielded from impinging light, although this may be not easy to do for small pixel sizes.

Turning to FIG. 7B, a near-eye display 770 includes the LC panel 700 of FIG. 7A, an illuminator 708 for illuminating the LC panel 700, and an ocular lens 710 for viewing the LC panel 700 at an eyebox 712. In operation, the illuminator 708 emits light illuminating the LC panel 700. The ocular lens converts the image displayed by the LC panel 700 into an angular domain image, i.e. an image where different image elements (pixels) are represented by different ray angles of the image light. Such images may be viewed directly in the eyebox 712. For transmissive LC panels 700, the illuminator 708 may be a backlight illuminator, and for reflective LC panels 700, the illuminator 708 may be a frontlight illuminator.

Referring to FIG. 8 with further reference to FIG. 7A, a method 800 may be used to increase a contrast ratio of an LC panel such as the LC panel 700 of FIG. 7A having the substrate 204, a layer comprising a plurality of rounded rectangular structures having a perimeter in a plane of the layer and refractive walls extending from the perimeter towards the substrate, such as the vias 228 having the rounded refractive sidewalls 230. The method 800 includes selecting (FIG. 8; 802) a sum length of rounded portions of the perimeter to be no greater than 50% of a total length of the perimeter of the rounded rectangular structures. As explained above with reference to FIGS. 6A to 6D, reducing the sum length of the rounded portions leads to lessening a contribution of rounded portions of the refractive walls to perturbation of a linear polarization of impinging light due to refraction of impinging light on the rounded portions of the refractive walls. The sum length of the rounded portions may be no greater than 30% of the total perimeter length or, in some embodiments, no greater than 10% of the total perimeter length.

In some embodiments, the area of the rounded portions is reduced by reducing the overall size of the round rectangular structures such as vias. For example, the structures may be small enough for the perimeter to be no longer than 40 micrometers, more preferably no longer than 24 micrometers, and more preferably no longer than 8 micrometers.

In some embodiments, the method 800 may include orienting (804) a linear polarizer supported by the substrate to have a transmission axis of the linear polarizer perpendicular or parallel to straight portions of the perimeter of the rounded rectangular structures. The method 800 may include index matching (806) the rounded rectangular structures to their surroundings to reduce the refraction of the impinging light by the rounded rectangular structures.

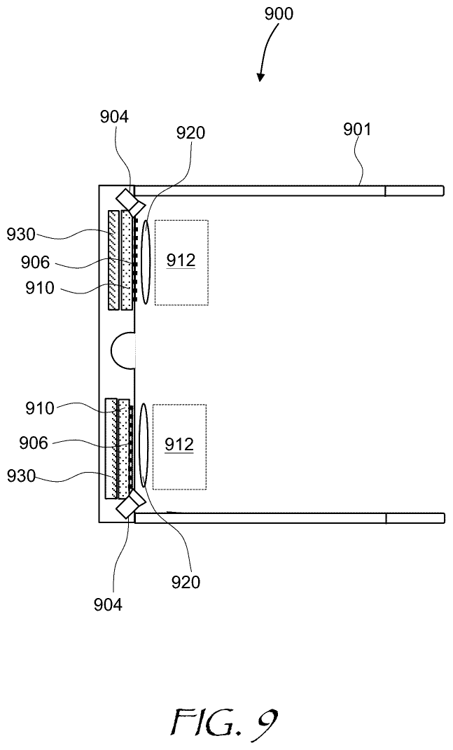

Referring to FIG. 9, a virtual reality (VR) near-eye display 900 includes a frame 901 supporting, for each eye: an illuminator 930; a display panel 910 including any of the LC panels disclosed herein; and an ocular lens 920 for converting the image in linear domain generated by the display panel 910 into an image in angular domain for direct observation at an eyebox 912. A plurality of eyebox illuminators 906, shown as black dots, may be placed around the display panel 910 on a surface that faces the eyebox 912. An eye-tracking camera 904 may be provided for each eyebox 912.

The purpose of the eye-tracking cameras 904 is to determine position and/or orientation of both eyes of the user. The eyebox illuminators 906 illuminate the eyes at the corresponding eyeboxes 912, allowing the eye-tracking cameras 904 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 906, the latter may be made to emit light invisible to the user. For example, infrared light may be used to illuminate the eyeboxes 912.

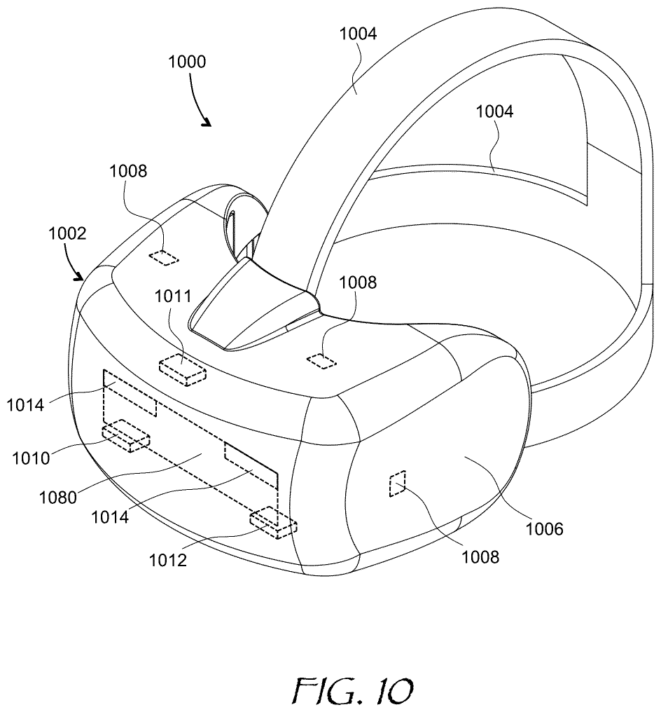

Turning to FIG. 10, an HMD 1000 is an example of an AR/VR wearable display system which encloses the user's face, for a greater degree of immersion into the AR/VR environment. The HMD 1000 may generate the entirely virtual 3D imagery. The HMD 1000 may include a front body 1002 and a band 1004 that can be secured around the user's head. The front body 1002 is configured for placement in front of eyes of a user in a reliable and comfortable manner. A display system 1080 may be disposed in the front body 1002 for presenting AR/VR imagery to the user. The display system 1080 may include any of the display panels disclosed herein. Sides 1006 of the front body 1002 may be opaque or transparent.

In some embodiments, the front body 1002 includes locators 1008 and an inertial measurement unit (IMU) 1010 for tracking acceleration of the HMD 1000, and position sensors 1012 for tracking position of the HMD 1000. The IMU 1010 is an electronic device that generates data indicating a position of the HMD 1000 based on measurement signals received from one or more of position sensors 1012, which generate one or more measurement signals in response to motion of the HMD 1000. Examples of position sensors 1012 include: one or more accelerometers, one or more gyroscopes, one or more magnetometers, another suitable type of sensor that detects motion, a type of sensor used for error correction of the IMU 1010, or some combination thereof. The position sensors 1012 may be located external to the IMU 1010, internal to the IMU 1010, or some combination thereof.

The locators 1008 are traced by an external imaging device of a virtual reality system, such that the virtual reality system can track the location and orientation of the entire HMD 1000. Information generated by the IMU 1010 and the position sensors 1012 may be compared with the position and orientation obtained by tracking the locators 1008, for improved tracking accuracy of position and orientation of the HMD 1000. Accurate position and orientation is important for presenting appropriate virtual scenery to the user as the latter moves and turns in 3D space.

The HMD 1000 may further include a depth camera assembly (DCA) 1011, which captures data describing depth information of a local area surrounding some or all of the HMD 1000. The depth information may be compared with the information from the IMU 1010, for better accuracy of determination of position and orientation of the HMD 1000 in 3D space.

The HMD 1000 may further include an eye tracking system 1014 for determining orientation and position of user's eyes in real time. The obtained position and orientation of the eyes also allows the HMD 1000 to determine the gaze direction of the user and to adjust the image generated by the display system 1080 accordingly. The determined gaze direction and vergence angle may be used to adjust the display system 1080 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1002.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A liquid crystal (LC) panel comprising:
opposed first and second substrates separated by a gap therebetween;
an LC layer in the gap, the LC layer comprising LC molecules; and
a structured layer parallel to the LC layer, the structured layer comprising a plurality of rounded rectangular structures having a perimeter in a plane of the structured layer and refractive walls extending from the perimeter towards the first or the second substrate, wherein a sum length of rounded portions of the perimeter is no greater than 50% of a total length of the perimeter.

2. The LC panel of claim 1, wherein the sum length of the rounded portion is no greater than 30% of the total perimeter length.

3. The LC panel of claim 2, wherein the sum length of the rounded portion is no greater than 10% of the total perimeter length.

4. The LC panel of claim 1, wherein the perimeter is no longer than 40 micrometers.

5. The LC panel of claim 4, wherein the perimeter is no longer than 24 micrometers.

6. The LC panel of claim 5, wherein the perimeter is no longer than 8 micrometers.

7. The LC panel of claim 1, further comprising a linear polarizer supported by the first substrate or the second substrate, wherein a transmission axis of the linear polarizer is perpendicular or parallel to straight portions of the perimeter of the rounded rectangular structures.

8. The LC panel of claim 1, wherein the structured layer comprises an active matrix layer disposed on the second substrate and facing the LC layer, for providing a spatially variant electric field distribution to the LC layer for spatially variant reorientation of the LC molecules in a plane of the LC layer, wherein:
the active matrix layer comprises the rounded rectangular structures; and
the rounded rectangular structures comprise vias for electrical coupling of different sub-layers of the active matrix layer.

9. The LC panel of claim 8, wherein the vias comprise a transparent oxide.

10. The LC panel of claim 8, wherein the active matrix layer further comprises a material surrounding the rounded rectangular structures, wherein the rounded rectangular structures are index matched to the surrounding material to within 0.1.

11. A method for increasing a contrast ratio of a liquid crystal (LC) panel comprising a substrate, a layer comprising a plurality of rounded rectangular structures having a perimeter in a plane of the layer, and refractive walls extending from the perimeter towards the substrate, the method comprising:
selecting a sum length of rounded portions of the perimeter to be no greater than 50% of a total length of the perimeter of the rounded rectangular structures, for lessening a contribution of rounded portions of the refractive walls to perturbation of a linear polarization of impinging light due to refraction of impinging light on the rounded portions of the refractive walls.

12. The method of claim 11, wherein the sum length of the rounded portions is no greater than 30% of the total perimeter length.

13. The method of claim 12, wherein the sum length of the rounded portions is no greater than 10% of the total perimeter length.

14. The method of claim 11, wherein the perimeter is no longer than 40 micrometers.

15. The method of claim 14, wherein the perimeter is no longer than 24 micrometers.

16. The method of claim 11, wherein the perimeter is no longer than 8 micrometers.

17. The method of claim 11, further comprising orienting a linear polarizer supported by the substrate to have a transmission axis of the linear polarizer perpendicular or parallel to straight portions of the perimeter of the rounded rectangular structures.

18. The method of claim 11, further comprising index matching the rounded rectangular structures to their surroundings to reduce the refraction of the impinging light by the rounded rectangular structures.

19. A near-eye display comprising:
a liquid crystal (LC) panel;
an illuminator for illuminating the LC panel; and
an ocular lens for viewing the LC panel;
the LC panel comprising:
opposed first and second substrates separated by a gap therebetween;
an LC layer in the gap, the LC layer comprising LC molecules; and
a structured layer parallel to the LC layer, the structured layer comprising a plurality of rounded rectangular structures having a perimeter in a plane of the structured layer and refractive walls extending from the perimeter towards the first or the second substrate, wherein a sum length of rounded portions of the perimeter is no greater than 50% of a total length of the perimeter.

20. The near-eye display of claim 19, wherein the structured layer comprises an active matrix layer disposed on the second substrate and facing the LC layer, for providing a spatially variant electric field distribution to the LC layer for spatially variant reorientation of the LC molecules in a plane of the LC layer, wherein:
the active matrix layer comprises the rounded rectangular structures; and
the rounded rectangular structures comprise vias for electrical coupling of different sub-layers of the active matrix layer.
